(19) United States
(12) Patent Application Publication
(10) Pub. No.: US 2008/0205087 A1
(43) Pub. Date: Aug. 28, 2008

(54) Power supply feedback control using sensed duty cycle

(76) Inventors: Arlaindo Vitug Asuncion, Paranaque City (PH); Evan Maniwang Espina, Quezon City (PH)

Correspondence Address: HARNESS, DICKEY, & PIERCE, P.L.C, 7700 Bonhomme, Suite 400, ST. LOUIS, MO, 63105, US

(21) Appl. No.: 11/711,525

(22) Filed: Feb. 27, 2007

(51) Int. Cl. H02M 3/22

(52) U.S. Cl. 363/15

(57) ABSTRACT

A feedback control circuit 10 is to be used with a power supply 12. Circuit 10 has a feedback controller 14 for providing a feedback signal to the power supply 12 in both continuous current mode and discontinuous current mode. A duty cycle sensor controller 16 is connected to the feedback controller for sensing a duty cycle of the power supply 12. The feedback controller optimizes the feedback signal provided to the power supply 12 for continuous current mode or discontinuous current mode based on the sensed duty cycle.

### FIELD

The present disclosure relates to feedback control of a power supply. More particularly, the present disclosure relates to feedback control of power supplies operating in continuous current mode (CCM) and in discontinuous current mode (DCM).

### BACKGROUND

The statements in this section merely provide background information related to the present disclosure and may not constitute prior art.

Most switch-mode power supplies are designed so that their magnetic energy storage elements (e.g. an inductor or transformer) operate in CCM from a full load down to the lowest allowed loading condition. Cost and size limitations of the magnetics often require the inductor or transformer to operate in DCM at lower levels of load. The cut-off level below which the power supply will operate in DCM is typically at 30% load. The feedback compensation for the power circuit operation can be optimized for CCM. Optimizing for CCM means that the power supply will have the fastest dynamic load response when it is operating in CCM. When the power supply enters DCM, the dynamic load response becomes slower. This limitation of optimizing for one mode is inherent when using known feedback control schemes employing ordinary op-amp circuits or other circuits with fixed feedback compensation.

It is becoming a requirement that power supplies provide a fast dynamic load response down to about 5% load. An example of a fast dynamic load response may be maintaining the output voltage over/undershoots within +/−5% of regulation for +/−50% load steps. This means that the feedback compensation of the power supply in DCM must equal or exceed the speed of the compensation in CCM. This is very difficult to do when using fixed feedback compensation because the open loop gain of the power stage is higher when it is in CCM and lower when it is in DCM. In other words, fixed feedback compensation means that the dynamic load response in CCM will be faster than in DCM.

To meet the requirement for dynamic load response under both continuous and discontinuous conduction mode, the feedback compensation must dynamically adapt with the operating mode of the power circuit. In the prior art, this dynamic adaptation was accomplished by first detecting the operating mode and then changing the feedback compensation.

A common way of detecting the operating mode is by monitoring the load current. This requires a current sensing network connected to the load or the magnetic component. Using a current sensing network presents some drawbacks. One drawback is the power loss in the sensing element, since the current sensing element is usually a resistor. Another drawback is the speed limitation of the sensing network. If the sensing network is looking at the current of a magnetic element (an output inductor for instance), the sensed signal needs to be filtered to remove high frequency components. The delay caused by filtering may be significant enough to render the current sense signal unusable to properly control the feedback compensation.

### SUMMARY

Further areas of applicability will become apparent from the description provided herein. It should be understood that the description and specific examples are intended for purposes of illustration only and are not intended to limit the scope of the present disclosure.

The present disclosure teaches an advantageous feedback control using sensed duty cycle to provide an effective way of timely detecting the operating mode to dynamically adjust the feedback compensation properly.

An example of the present disclosure is a feedback control circuit for use with a power supply. A feedback controller is for providing feedback signals to the power supply in both continuous current mode and discontinuous current mode to maintain output regulation. A duty cycle sensor controller connected to the feedback controller senses a duty cycle of the power supply. The feedback controller optimizes the feedback signal provided to the power supply for continuous current mode or discontinuous current mode based on the sensed duty cycle.

### DRAWINGS

The drawings described herein are for illustration purposes only and are not intended to limit the scope of the present disclosure in any way.

FIG. 1 is an example of a feedback control circuit in accordance with the present disclosure;

FIG. 2 is a graph of duty cycle v load of a typical power supply;

FIG. 3 is an exemplary flow diagram in accordance with the present disclosure; and

FIG. 4 is an example of an analog feedback control circuit in accordance with the present disclosure.

### DETAILED DESCRIPTION

The following description is merely exemplary in nature and is not intended to limit the present disclosure, application, or uses.

The present disclosure provides an effective way of detecting the operating mode of the magnetic element of the power supply for dynamically and timely providing feedback control to a power supply. The present disclosure uses readily obtainable duty cycle information as the basis for detecting the operating mode.

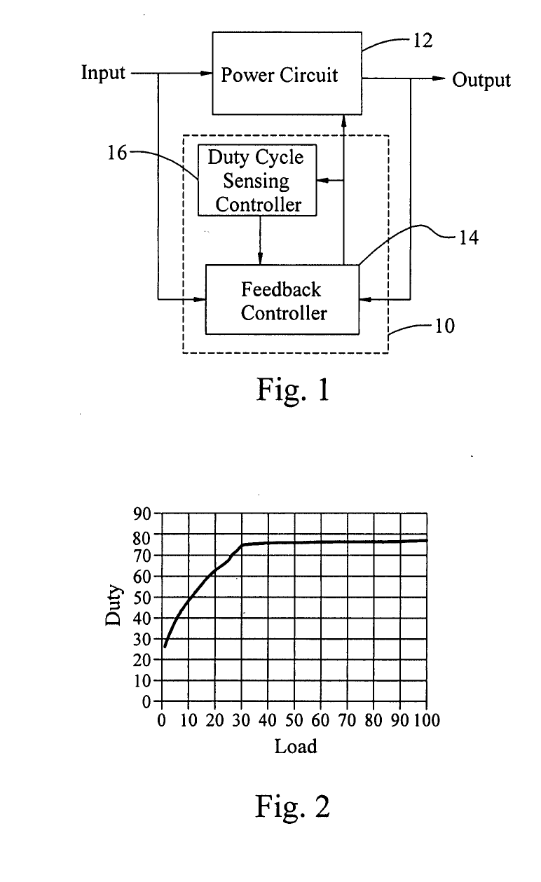

FIG. 1 shows a block diagram of a feedback control circuit 10, in accordance with the present disclosure. Circuit 10 is typically connected to a power circuit or power supply 12. Circuit 10 includes a feedback controller 14 for providing feedback signals to power circuit 12 in both continuous current mode and discontinuous current mode. A duty cycle sensor controller 16 is connected to the feedback controller 14. Duty cycle sensor 16 senses a duty cycle of the power supply 12. The feedback controller 14 optimizes the feedback signal provided to the power supply 12 for continuous current mode or discontinuous current mode based on the sensed duty cycle.

The following discloses an example of the feedback control provided by the present disclosure using a regulated buck converter with an input of 16V and an output of 12V. The maximum load requirement is 100 A. A typical design of the inductor will usually result in a critically discontinuous load of 30% or 30 A. As those skilled in the art will appreciate, the level at which DCM begins is generally dictated by the cost and size tradeoffs for the inductor design. The power supply is required to deliver a dynamic load (step load) of 20 A starting from 2 A. A typical duty cycle v load characteristic is shown in FIG. 2. From the equation V_{Out}=Vᵢₙ*Duty Cycle for a CCM operation, it can be seen that the duty cycle is theoretically constant under any load condition in CCM. For the present example, Duty Cycle=75% in CCM. There is only a small change in duty cycle as the load increases, which is due to circuit parasitics and track losses. When the duty cycle is at 75% or higher, it can be safely assumed that the power circuit is in CCM and the feedback compensation can be optimized for CCM operation.

When the load is decreased and the converter enters DCM, the duty cycle becomes proportional to the square root of the load current. If the load current is normalized to the critical DCM, the equation for the duty cycle becomes:

Dnorm=\sqrt{Inorm}
where:
   Dnorm—duty cycle normalized to continuous conduction mode operation
   Inorm—Load current normalized to critically discontinuous mode
      Dnorm=1 when the duty cycle is for continuous current mode operation (75% or above for the present example). Inorm =1 when the load current is such that the converter is in critically discontinuous current mode (below 75% for the present example) and Inorm=0.5 when the load current is one-half of the critically discontinuous current mode.

If a fixed feedback compensation were used that is optimized for CCM, the output voltage overshoot and undershoot requirements can be met if the dynamic load is in the region of 30 A to 100 A. However, if the load condition is in DCM (for example 2 A to 22 A dynamic load), the fixed feedback compensation results in a slower response because the gain of the power circuit is lower in DCM. Because of the slower response the output voltage of the power circuit likely will exceed the overshoot and undershoot limits.

Therefore, it can be seen that faster feedback compensation is required for DCM. If the fixed feedback compensation is optimized for DCM, the dynamic load response in DCM can be improved; but the feedback loop will tend to become unstable in CCM. This problem may be overcome by switching to the appropriate compensation for each of the two operating modes. If the detection of the operating mode is not fast enough, the problem will not be solved when the dynamic load is crossing the boundary between the continuous and discontinuous modes.

For example, assume the load is at 40 A and then the load is required to step down to 20 A. In such a condition, the power supply will transition from CCM to DCM when passing through a mode boundary at about the 30 A level. The current compensation starts out being optimized for CCM and the power supply is achieving a fast response at the duty cycle for 40 A to 30 A load. As the power supply tries to correct at the duty cycles from a 30 A to 20 A load, the circuit will be too slow unless its compensation is change almost instantly.

To change the feedback compensation almost instantaneously to match the operating mode, the present disclosure uses sensed duty cycle information. From the example above, the initial load was at 40 A and the initial duty cycle is about 75% (from FIG. 2). The initial feedback compensation is optimized for CCM. When there is a step load from 40 A to 20 A, the CCM feedback compensation can quickly set a duty cycle of 74% for a load of 30 A. But once the load is stepped down to 20 A, the CCM feedback control needs to reduce the duty cycle further down to 62%. Since the duty cycle information is available, the CCM control is able to determine that the duty cycle is now 74% and the feedback loop is trying to correct by reducing the duty cycle further down to 73% then 72% and so on. If the feedback loop continues to change the duty cycle at the rate dictated by the feedback compensation for CCM, the output voltage will exceed the overshoot limit. However, because the feedback controller 14 knows that the duty cycle is now at 72% from the sensor 16, controller 14 can quickly switch to the feedback compensation for DCM. This results in a faster compensation and a faster decrease in duty cycle of the power circuit 12. The 62% duty cycle at 20 A will be reached faster and the output voltage of power circuit 12 will not exceed the overshoot limit. The same scenario applies when the condition is in the reverse direction, meaning the load is at 20 A and it steps up to 40 A.

The equations above show that if the duty cycle is lower than the duty cycle required in the continuous conduction mode (75% for our example), then the operating mode is discontinuous. This information is predetermined and is preferably pre-loaded into the controller 14. This is applicable under steady state conditions and is also true under dynamic load conditions with certain limitations. The dynamic load limitations require that feedback control remains closed loop and does not saturate and that the magnetic components of circuit 12 do not saturate. It will be appreciated that the duty cycle information may be used to determine the mode of operation almost instantaneously by sensing the duty cycle and then adapting the feedback compensation based on the sensed duty cycle information.

When operating in discontinuous mode, it is desirable to have a continuously variable gain or feedback compensation as the duty cycle changes. However, to minimize the computing resource requirements when using digital control (as shown in FIG. 1), the discontinuous region can be divided into multiple sections and assigned discrete steps of gain or feedback compensation for each section.

Preferably, the feedback controller 14 includes a memory (not shown) for storing a minimum duty cycle for CCM. The controller 14 optimizes the feedback signal for CCM if the sensed duty cycle is equal to or greater than the stored minimum duty cycle. Conversely, the controller 14 optimizes the feedback signal for DCM if the sensed duty cycle is less than the stored minimum duty cycle.

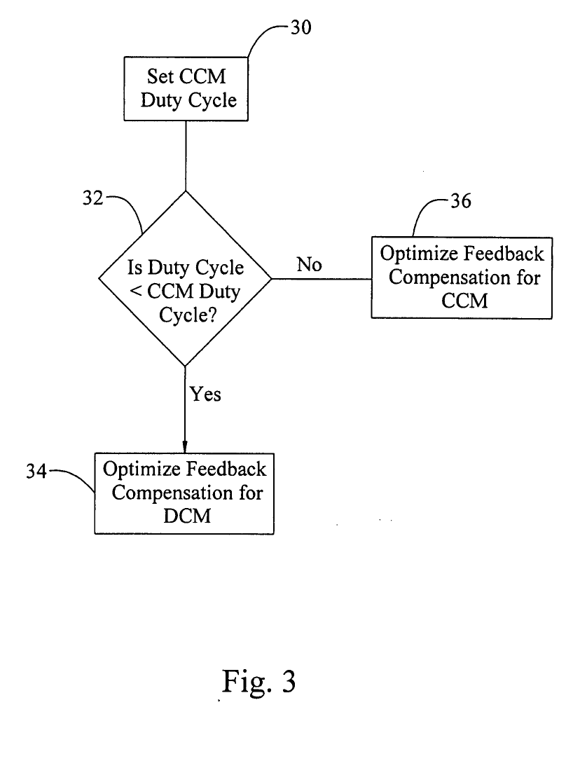

FIG. 3 is a flow diagram of a method of providing a feedback control signal to a power supply. Step 30 sets a minimum duty cycle for the power supply 12 to be in CCM. Step 32 senses a duty cycle of the power supply 12 and determines if the sensed duty cycle is less than the set minimum duty cycle. If the answer to step 32 is yes, step 34 optimizes the feedback control signal applied to the power supply 12 for DCM. If the answer to step 32 is no, step 36 optimizes the feedback control signal applied to the power supply 12 for CCM.

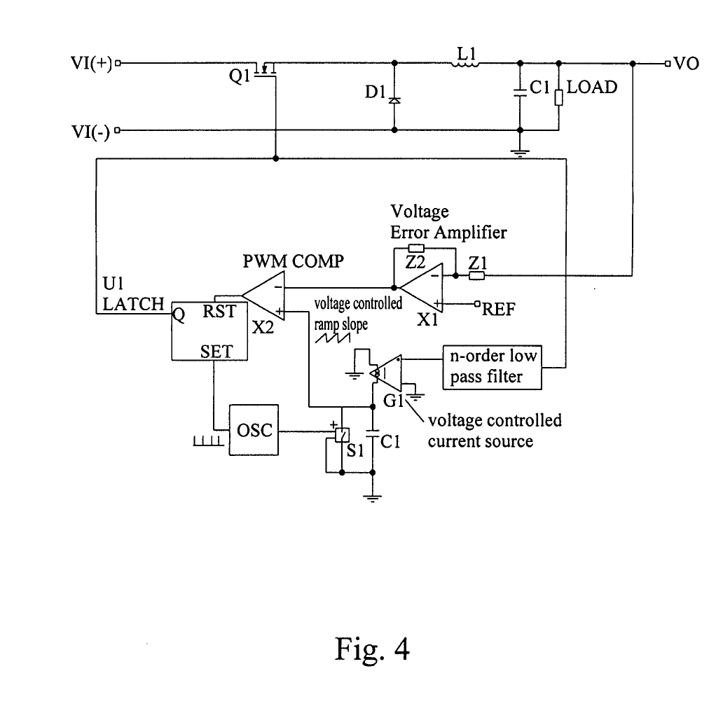

FIG. 4 shows an analog implementation in accordance with the present disclosure. FIG. 4 is basically a voltage mode controller that uses the duty cycle to control the slope of the ramp. The duty cycle is filtered to get the dc component. A second order or higher order filter is used to get a sharp roll-off at the cutoff frequency. An increase in duty cycle will increase the slope of the ramp. This in turn results in a lower gain as duty cycle increases.

The present disclosure provides a feedback control circuit that has many benefits over the prior art. The circuit 10 improves the load transient response of power supplies operating in both continuous and discontinuous conduction modes. The circuit 10 operates without any current information; thus, eliminating the need for a current sense network and reducing cost and parts count. The feedback control circuit can be implemented in either analog and digital control. For digital control, software implementation allows for an easier debugging process; thus, leading to a shorter design cycle and faster time to market.

Any Buck derived topology that operates in both continuous and discontinuous conduction mode which is required to meet tight dynamic load response may benefit from the present disclosure. The present disclosure can also be applied to Boost and Buck-Boost Topologies or other topologies derived from these two.

The description of the present disclosure is merely exemplary and those skilled in the art will appreciate that variations other than those described will fall within the scope of the present disclosure.

What is claimed:

1. A feedback control circuit for use with a power supply comprising:
a feedback controller for providing feedback signals to the power supply in both continuous current mode and discontinuous current mode;
a duty cycle sensor controller connected to the feedback controller for sensing a duty cycle of the power supply; and
wherein the feedback controller optimizes the feedback signal provided to the power supply for continuous current mode or discontinuous current mode based on the sensed duty cycle.

2. The feedback control circuit of claim 1, wherein the circuit is implemented digitally.

3. The feedback control circuit of claim 1, wherein the circuit is implemented as an analog circuit.

4. The feedback control circuit of claim 1, wherein the feedback controller includes a memory for storing a minimum duty cycle for continuous current mode and wherein the feedback controller optimizes the feedback signal for continuous current mode if the sensed duty cycle is equal to or greater than the stored minimum duty cycle and the feedback signal is optimized for discontinuous current mode if the sensed duty cycle is less than the stored minimum duty cycle.

5. The feedback control circuit of claim 1, wherein the feedback signal is continuously variable with a change in the sensed duty cycle.

6. The feedback control circuit of claim 1, wherein the feedback control signal varies in discrete steps as the sensed duty cycle changes.

7. A power supply feedback control circuit comprising:
a power circuit having an input and an output;
a feedback controller connected to the input and output provides a feedback signal to the power circuit that is optimized for a continuous current mode and a discontinuous current mode;
a duty cycle sensor connected to the power circuit and the feedback controller for sensing a duty cycle of the power circuit; and
wherein the feedback controller optimizes the feedback signal for continuous current mode or discontinuous mode based on the sensed duty cycle.

8. The power supply feedback control circuit of claim 7, wherein the circuit is implemented digitally.

9. The power supply feedback control circuit of claim 7, wherein the circuit is implemented as an analog circuit.

10. The power supply feedback control circuit of claim 7, wherein the feedback controller includes a memory for storing a minimum duty cycle for continuous current mode and wherein the feedback controller optimizes the feedback signal for continuous current mode if the sensed duty cycle is equal to or greater than the stored minimum duty cycle and the feedback signal is optimized for discontinuous current mode if the sensed duty cycle is less than the stored minimum duty cycle.

11. The power supply feedback control circuit of claim 7, wherein the feedback signal is continuously variable with a change in the sensed duty cycle.

12. The power supply feedback control circuit of claim 7, wherein the feedback control signal varies in discrete steps as the sensed duty cycle changes.

13. A method of providing a feedback control signal to a power supply, comprising the steps of:
sensing a duty cycle of the power supply;
setting a minimum duty cycle for the power supply to be in continuous current mode;
determining if the sensed duty cycle is less than the set minimum duty cycle;
optimizing the feedback control signal applied to the power supply for a discontinuous current mode if the sensed duty cycle is less than the set minimum duty cycle; and
optimizing the feedback control signal applied to the power supply for continuous current mode if the sensed duty cycle is equal to or greater than the set minimum duty cycle.
